(19) United States
(12) Patent Application Publication
(10) Pub. No.: US 2020/0039125 A1
(43) Pub. Date: Feb. 6, 2020

(54) METHOD FOR MANUFACTURING RESIN MOLDED BODY AND RESIN MOLDED BODY

(71) Applicant: Sumitomo Chemical Company, Limited, Tokyo (JP)

(72) Inventor: Hidehiro KOTAKA, Tsukuba-shi, Ibaraki (JP)

(21) Appl. No.: 16/494,858

(22) PCT Filed: Mar. 19, 2018
(86) PCT No.: PCT/JP2018/010844

§ 371 Date: Sep. 17, 2019

(30) Foreign Application Priority Data
Mar. 22, 2017 (JP) 2017-055488

(51) Int. Cl. B29C 45/00; B29C 45/26; B29C 45/27

(52) U.S. Cl. CPC B29C 45/0001; B29K 2067/04; B29C 45/2708; B29C 45/2602

(57) ABSTRACT

A method for manufacturing a long-length resin molded body using a liquid crystal polyester is provided. The method includes injecting a resin composition containing the liquid crystal polyester via a gate into a cavity of a mold and filling the cavity with the resin composition. The mold cavity has a shape corresponding with the resin molded body and a gate is provided in a position where the distance from an end edge of the cavity in a long-length direction of the cavity is not more than 10% of the length of the long-length direction. The ratio of the length of the long-length direction relative to a length of a short-length direction of the cavity is two or greater. The length of the long-length direction is 200 mm or greater. A thickness of the cavity is at least 0.5 mm but not more than 3.0 mm.

### TECHNICAL FIELD

The present invention relates to a method for manufacturing a resin molded body and a resin molded body.

Priority is claimed on Japanese Patent Application No. 2017-055488, filed Mar. 22, 2017, the content of which is incorporated herein by reference.

### BACKGROUND ART

Molded bodies obtained from liquid crystal polymers such as liquid crystal polyesters have high strength, superior heat resistance and superior dimensional precision, and are therefore used as forming materials for comparatively small electronic components such as connectors and relay components (for example, see Patent Document 1). These types of molded bodies are molded by injection molding.

### PRIOR ART LITERATURE

### Patent Document

Patent Document 1: JP H07-126383 A

### SUMMARY OF THE INVENTION

### Problems to be Solved by the Invention

In recent years, by utilizing the above types of features of liquid crystal polyesters, investigations have been conducted into the use of liquid crystal polyesters as forming materials for large molded bodies. Examples of “large molded bodies” include exterior components of electrical appliances and vehicles (automobiles).

The present invention has been developed in light of these circumstances, and has an object of providing a method for manufacturing a resin molded body that enables a favorable resin molded body to be manufactured using a liquid crystal polyester as a forming material. Further, the present invention also has an object of providing a resin molded body obtained using this manufacturing method.

### Means for Solving the Problems

As a result of investigating the use of liquid crystal polyesters as forming materials for large molded bodies, the inventors of the present invention noticed that when a large molded body was produced by injection molding using a liquid crystal polyester as the forming material, warping of the obtained molded body sometimes increased. Further, they also found that when the obtained molded body was exposed to a high-temperature environment, warping of the molded body sometimes increased.

It is known that the molecular chains of liquid crystal polyesters tend to readily orient along the resin flow direction during injection molding, and that the shrinkage factor differs between the resin flow direction and the direction orthogonal to the resin flow direction. Conventionally, in small molded bodies in which a liquid crystal polyester were used as the forming material, the degree of warping caused by differences in the shrinkage factor relative to the resin flow direction was small, but it is thought that in large molded bodies, the above difference in the shrinkage factor tends to manifest more readily a warping of the molded body.

Taking these circumstances into account, the inventors of the present invention conducted intensive investigation into the development of large molded bodies having little warping, and particularly long-length molded bodies having little warping, thereby completing the present invention.

One aspect of the present invention provides a method for manufacturing a long-length resin molded body using a liquid crystal polyester as a forming material, the method having a step of performing injection molding of a resin composition containing a liquid crystal polyester using a mold that satisfies conditions (a) to (d) below.

(a) The mold has a cavity of a shape corresponding with the resin molded body, and a gate provided in a position where the distance from an end edge of the cavity in the long-length direction of the cavity is not more than 10% of the length of the long-length direction of the cavity.

(b) The ratio (L/W) of the length (L) of the long-length direction of the cavity relative to the length (W) of the short-length direction of the cavity is two or greater.

(c) The length (L) of the long-length direction of the cavity is 200 mm or greater.

(d) The thickness (H) of the cavity is at least 0.5 mm but not more than 3.0 mm.

One aspect of the present invention may be the manufacturing method described above wherein, in the step of performing injection molding, a mold is used which, in addition to the conditions (a) to (d) described above, also satisfies a condition (e) below.

(e) The ratio (W/H) of the length of the short-length direction (W) of the cavity relative to the thickness (H) of the cavity is 10 or greater.

One aspect of the present invention may be the manufacturing method described above wherein, in the condition (b), the ratio (L/W) of the length (L) of the long-length direction of the cavity relative to the length (W) of the short-length direction of the cavity is three or greater.

One aspect of the present invention provides a resin molded body that satisfies conditions (i) to (iv) below.

(i) The resin molded body has a gate mark provided in a position where the distance from an end edge of the resin molded body in the long-length direction of the resin molded body is not more than 10% of the length of the long-length direction of the resin molded body.

(ii) The ratio (L/W) of the length (L) of the long-length direction of the resin molded body relative to the length (W) of the short-length direction of the resin molded body is two or greater.

(iii) The length (L) of the long-length direction of the resin molded body is 200 mm or greater.

(iv) The thickness (H) of the resin molded body is at least 0.5 mm but not more than 3.0 mm.

In one aspect of the present invention, the resin molded body may have a structure which, in addition to the conditions (i) to (iv) described above, also satisfies a condition (v) below.

(v) The ratio (W/H) of the length of the short-length direction (W) of the resin molded body relative to the thickness (H) of the resin molded body is 10 or greater.

In one aspect of the present invention, the resin molded body may have a structure wherein the degree of orientation f, calculated based on formula (I) and formula (II) using the cumulative value for optical density corresponding with a range from 1470 cm⁻¹ to 1510 cm⁻¹ in the polarized infrared absorption spectra of the resin molded body, is at least 0.40 but less than 1.00.

D=(X₁/X₂) (I)

f=(D−1)/(D+2) (II)

(X₁: the cumulative value for the optical density in the absorption spectrum when the plane of incidence is set parallel to the long-length direction of the resin molded body in the upper surface of the resin molded body when viewed in plan view, and measurement is conducted in the center of the upper surface using first polarized infrared rays having a vibration direction parallel to the plane of incidence.
X₂: the cumulative value for the optical density in the absorption spectrum when measurement is conducted in the center of the upper surface using second polarized infrared rays having a vibration direction orthogonal to the plane of incidence.)

In one aspect of the present invention, the resin molded body may contain a filler, and a liquid crystal polyester having repeating units represented by general formulas (1) to (3) below.

—O—Ar¹—CO— (1)

—CO—Ar²—CO— (2)

—X—Ar³—Y— (3)

(In the formulas, Ar¹ represents a phenylene group, a naphthylene group, or a biphenylylene group. Each of Ar² and Ar³ independently represents a phenylene group, a naphthylene group, a biphenylylene group, or a group represented by general formula (4) below. Each of X and Y independently represents an oxygen atom or an imino group (—NH—). One or more hydrogen atoms in a group represented by Ar¹, Ar² or Ar³ may each be independently substituted with a halogen atom, an alkyl group or an aryl group.)

—Ar⁴—Z—Ar⁵— (4)

(In the formula, each of Ar⁴ and Ar⁵ independently represents a phenylene group or a naphthylene group. Z represents an oxygen atom, sulfur atom, carbonyl group, sulfonyl group or alkylidene group.

In one aspect of the present invention, the filler may be a fibrous filler or a plate-like filler.

In one aspect of the present invention, the resin molded body may have a structure wherein, relative to the total amount of all the repeating units that constitute the liquid crystal polyester, the amount of repeating units represented by general formula (1) is from 30 to 80 mol %, the amount of repeating units represented by general formula (2) is from 10 to 35 mol %, and the amount of repeating units represented by general formula (3) is from 10 to 35 mol %.

In one aspect of the present invention, the resin molded body may have a structure wherein, in the condition (ii) described above, the ratio (L/W) of the length (L) of the long-length direction of the resin molded body relative to the length (W) of the short-length direction of the resin molded body is three or greater.

In other words, the present invention includes the following aspects.

[1] A method for manufacturing a long-length resin molded body using a liquid crystal polyester as a forming material, the method comprising:

injecting a resin composition containing the liquid crystal polyester via a gate into a cavity of a mold that satisfies conditions (a) to (d) below, and filling the cavity with the resin composition.

(a) The mold has a cavity of a shape corresponding with the resin molded body, and a gate provided in a position where the distance from an end edge of the cavity in the long-length direction of the cavity is not more than 10% of the length of the long-length direction of the cavity.

(b) The ratio (L/W) of the length (L) of the long-length direction of the cavity relative to the length (W) of the short-length direction of the cavity is two or greater.

(c) The length (L) of the long-length direction of the cavity is 200 mm or greater.

(d) The thickness (H) of the cavity is at least 0.5 mm but not more than 3.0 mm.

[2] The method for manufacturing a resin molded body according to [1], wherein the mold also satisfies a condition (e) below, in addition to the conditions (a) to (d) described above.

(e) The ratio (W/H) of the length of the short-length direction (W) of the cavity relative to the thickness (H) of the cavity is 10 or greater.

[3] The method for manufacturing a resin molded body according to [1] or [2], wherein, in the condition (b), the ratio (L/W) of the length (L) of the long-length direction of the cavity relative to the length (W) of the short-length direction of the cavity is three or greater.
[4] A resin molded body that satisfies conditions (i) to (iv) below.

(i) The resin molded body has a gate mark provided in a position where the distance from an end edge of the resin molded body in the long-length direction of the resin molded body is not more than 10% of the length of the long-length direction of the resin molded body.

(ii) The ratio (L/W) of the length (L) of the long-length direction of the resin molded body relative to the length (W) of the short-length direction of the resin molded body is two or greater.

(iii) The length (L) of the long-length direction of the resin molded body is 200 mm or greater.

(iv) The thickness (H) of the resin molded body is at least 0.5 mm but not more than 3.0 mm.

[5] The resin molded body according to [4], which also satisfies a condition (v) below, in addition to the conditions (i) to (iv) described above.

(v) The ratio (W/H) of the length of the short-length direction (W) of the resin molded body relative to the thickness (H) of the resin molded body is 10 or greater.

[6] The resin molded body according to [4] or [5], wherein when the degree of orientation f is calculated based on formula (I) below and formula (II) below using the cumulative value for optical density corresponding with a range from 1470 cm⁻¹ to 1510 cm⁻¹ in the polarized infrared absorption spectra of the resin molded body, the degree of orientation f is at least 0.40 but less than 1.00.

D=(X₁/X₂) (I)

f=(D−1)/(D+2) (II)

(X₁: the cumulative value for the optical density in the absorption spectrum when the plane of incidence is set parallel to the long-length direction of the resin molded body in the upper surface of the resin molded body when viewed in plan view, and measurement is conducted in the center of the upper surface using first polarized infrared rays having a vibration direction parallel to the plane of incidence.
X₂: the cumulative value for the optical density in the absorption spectrum when measurement is conducted in the center of the upper surface using second polarized infrared rays having a vibration direction orthogonal to the plane of incidence.)
[7] The resin molded body according to any one of [4] to [6], comprising a filler, and a liquid crystal polyester having repeating units represented by general formulas (1) to (3) below.

—O—Ar¹—CO— (1)

—CO—Ar²—CO— (2)

—X—Ar³—Y— (3)

(In the formulas, Ar¹ represents a phenylene group, a naphthylene group, or a biphenylylene group; each of Ar² and Ar³ independently represents a phenylene group, a naphthylene group, a biphenylylene group, or a group represented by general formula (4) below; each of X and Y independently represents an oxygen atom or an imino group (—NH—); and one or more hydrogen atoms in a group represented by Ar¹, Ar² or Ar³ may each be independently substituted with a halogen atom, an alkyl group or an aryl group.)

—Ar⁴—Z—Ar⁵— (4)

(In the formula, each of Ar⁴ and Ar⁵ independently represents a phenylene group or a naphthylene group; and Z represents an oxygen atom, sulfur atom, carbonyl group, sulfonyl group or alkylidene group.
[8] The resin molded body according to [7], wherein the filler is a fibrous filler or a plate-like filler.
[9] The resin molded body according to [7] or [8], wherein relative to the total number of moles of all the repeating units that constitute the liquid crystal polyester, the amount of repeating units represented by general formula (1) is from 30 to 80 mol %, the amount of repeating units represented by general formula (2) is from 10 to 35 mol %, and the amount of repeating units represented by general formula (3) is from 10 to 35 mol %.
[10] The resin molded body according to any one of [4] to [9], wherein in the condition (ii) described above, the ratio (L/W) of the length (L) of the long-length direction of the resin molded body relative to the length (W) of the short-length direction of the resin molded body is three or greater.

### Effects of the Invention

One aspect of the present invention provides a manufacturing a resin molded body that enables the manufacture of a favorable resin molded body using a liquid crystal polyester as a forming material. Further, a resin molded body obtained using this manufacturing method is also provided.

### BRIEF DESCRIPTION OF THE DRAWINGS

FIG. 1 is a schematic plan view illustrating the flow of the resin composition when producing a rectangular resin molded body.

FIG. 2A is a schematic diagram illustrating a method for manufacturing a resin molded body using a mold that represents one embodiment of the present invention.

FIG. 2B is a schematic diagram illustrating a method for manufacturing a resin molded body using a mold that represents one embodiment of the present invention.

FIG. 3 is a schematic perspective view illustrating a resin molded body that represents one embodiment of the present invention.

FIG. 4 is a diagram illustrating polarized infrared absorption spectra of a resin molded body that represents one embodiment of the present invention.

FIG. 5 is a schematic perspective view illustrating a mold used in the examples of the present invention.

FIG. 6 is a plan view illustrating warping measurement points on a resin molded body of an example of the present invention.

FIG. 7 is a plan view illustrating a measurement point for measuring the polarized infrared absorption spectrum in a resin molded body of an example of the present invention.

### EMBODIMENTS FOR CARRYING OUT THE PRESENT INVENTION

A method for manufacturing a resin molded body and a resin molded body that represent embodiments of the present invention are described below with reference to the drawings. In all of the drawings, the dimensions of the various constituent elements and the ratios between those dimensions and the like have been altered where appropriate to facilitate viewing of the drawings.

### <Method for Manufacturing Resin Molded Body>

The method for manufacturing a resin molded body that represents one embodiment of the present invention is a method for manufacturing a long-length resin molded body using a liquid crystal polyester as a forming material.

### [Liquid Crystal Polyester]

The liquid crystal polyester used in the method for manufacturing a resin molded body according to one embodiment of the present invention is one type of thermotropic liquid crystal polymer, and enables a melt that exhibits optical anisotropy to be molded at a temperature of not more than 450° C. (for example, at least 250° C. but not more than 450° C.).

The liquid crystal polyester used in the present embodiment preferably has a repeating unit represented by general formula (1) shown below (hereinafter sometimes referred to as “repeating unit (1)”), and more preferably has the repeating unit (1), a repeating unit represented by general formula (2) shown below (hereinafter sometimes referred to as “repeating unit (2)”), and a repeating unit represented by general formula (3) shown below (hereinafter sometimes referred to as “repeating unit (3)”).

—O—Ar¹—CO— (1)

—CO—Ar²—CO— (2)

—X—Ar³—Y— (3)

(In formulas (1) to (3), Ar¹ represents a phenylene group, a naphthylene group, or a biphenylylene group; each of Ar² and Ar³ independently represents a phenylene group, a naphthylene group, a biphenylylene group, or a group represented by general formula (4) shown below; each of X and Y independently represents an oxygen atom or an imino group (—NH—); and one or more hydrogen atoms in the groups represented by Ar¹, Ar² and Ar³ may each be independently substituted with a halogen atom, an alkyl group or an aryl group.)

—Ar⁴—Z—Ar⁵— (4)

(In formula (4), each of Ar⁴ and Ar⁵ independently represents a phenylene group or a naphthylene group; and Z represents an oxygen atom, sulfur atom, carbonyl group, sulfonyl group or alkylidene group.)

Specific examples of the liquid crystal polyester used in the present embodiment include:

(1)′ liquid crystal polyesters obtained by polymerizing a combination of an aromatic hydroxycarboxylic acid, an aromatic dicarboxylic acid, and an aromatic diol,

(2)′ liquid crystal polyesters obtained by polymerizing a plurality of aromatic hydroxycarboxylic acids,

(3)′ liquid crystal polyesters obtained by polymerizing a combination of an aromatic dicarboxylic acid and an aromatic diol, and

(4)′ liquid crystal polyesters obtained by reacting an aromatic hydroxycarboxylic acid with crystalline polyester such as polyethylene terephthalate.

In the production of the liquid crystal polyester, a portion or all of each of the aromatic hydroxycarboxylic acid, the aromatic dicarboxylic acid and the aromatic diol used as raw material monomers may be replaced with an ester-forming derivative in the polymerization. Using this type of ester-forming derivative offers the advantage of enabling the liquid crystal polyester to be produced more easily.

In this description, an “ester-forming derivative” means a monomer having a group for which an ester-producing reaction or a transesterification reaction can proceed.

Examples of the ester-forming derivative include ester-forming derivatives of aromatic hydroxycarboxylic acids and aromatic dicarboxylic acids having a carboxyl group in the molecule, and ester-forming derivatives of compounds having a phenolic hydroxyl group such as aromatic hydroxycarboxylic acids and aromatic diols.

Examples of the ester-forming derivatives of aromatic hydroxycarboxylic acids and aromatic dicarboxylic acids having a carboxyl group in the molecule include compounds in which the carboxyl group has been converted to a group of high reactivity such as a haloformyl group (an acid halide) or an acyloxycarbonyl group (an acid anhydride), and compounds in which the carboxyl group has formed an ester with a monohydric alcohol, a polyhydric alcohol such as ethylene glycol, or a phenol or the like, thus enabling a polyester to be produced by a transesterification reaction.

Examples of the ester-forming derivatives of compounds having a phenolic hydroxyl group such as aromatic hydroxycarboxylic acids and aromatic diols include compounds in which the phenolic hydroxyl group has formed an ester with a lower carboxylic acid, thus enabling a polyester to be produced by a transesterification reaction.

Moreover, provided the ester-forming properties are not impaired, the above-mentioned aromatic hydroxycarboxylic acids, aromatic dicarboxylic acids and aromatic diols may have, as a substituent on the aromatic ring, a halogen atom such as a chlorine atom or fluorine atom; an alkyl group of 1 to 10 carbon atoms such as a methyl group, ethyl group or butyl group; or an aryl group of 6 to 20 carbon atoms such as a phenyl group.

Examples of the aromatic hydroxycarboxylic acids include p-hydroxybenzoic acid (an aromatic hydroxycarboxylic acid that yields a repeating unit represented by (A₁) shown below), m-hydroxybenzoic acid and 6-hydroxy-2-naphthoic acid (aromatic hydroxycarboxylic acids that yield a repeating unit represented by (A₂) shown below), 3-hydroxy-2-naphthoic acid, 5-hydroxy-1-naphthoic acid, 4-hydroxy-4′-carboxydiphenyl ether, and aromatic hydroxycarboxylic acids in which a portion of the hydrogen atoms on the aromatic ring(s) of one of the above aromatic hydroxycarboxylic acids have each been substituted with at least one type of substituent selected from the group consisting of alkyl groups, aryl groups and halogen atoms. In the production of the liquid crystal polyester, one of the above aromatic hydroxycarboxylic acids may be used alone, or a combination of two or more aromatic hydroxycarboxylic acids may be used.

The repeating unit (1) described above is a repeating unit derived from a specific aromatic hydroxycarboxylic acid. Examples of repeating units derived from an aromatic hydroxycarboxylic acid include the units shown below. The repeating unit derived from an aromatic hydroxycarboxylic acid may have a portion of the hydrogen atoms on the aromatic ring(s) each substituted with at least one type of substituent selected from the group consisting of halogen atoms, alkyl groups and aryl groups.

In this description, “derived” means a change in chemical structure from the raw material monomer due to polymerization.

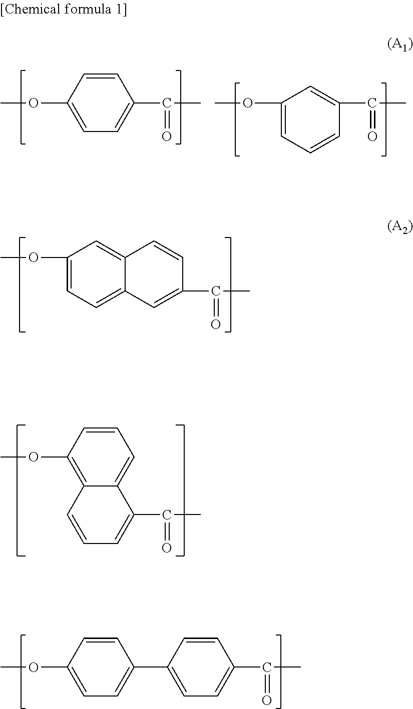

Examples of the aromatic dicarboxylic acids include terephthalic acid (an aromatic dicarboxylic acid that yields a repeating unit represented by (B₁) shown below), isophthalic acid (an aromatic dicarboxylic acid that yields a repeating unit represented by (B₂) shown below), biphenyl-4,4′-dicarboxylic acid and 2,6-naphthalenedicarboxylic acid (aromatic dicarboxylic acids that yield a repeating unit represented by (B₃) shown below), diphenyl ether-4,4′-dicarboxylic acid, diphenyl thioether-4,4′-dicarboxylic acid, and aromatic dicarboxylic acids in which a portion of the hydrogen atoms on the aromatic ring(s) of one of the above aromatic dicarboxylic acids have each been substituted with at least one type of substituent selected from the group consisting of alkyl groups, aryl groups and halogen atoms. In the production of the liquid crystal polyester, one of the above aromatic dicarboxylic acids may be used alone, or a combination of two or more aromatic dicarboxylic acids may be used.

The repeating unit (2) described above is a repeating unit derived from a specific aromatic dicarboxylic acid. Examples of repeating units derived from an aromatic dicarboxylic acid include the units shown below. The repeating unit derived from an aromatic dicarboxylic acid may have a portion of the hydrogen atoms on the aromatic ring(s) each substituted with at least one type of substituent selected from the group consisting of halogen atoms, alkyl groups and aryl groups.

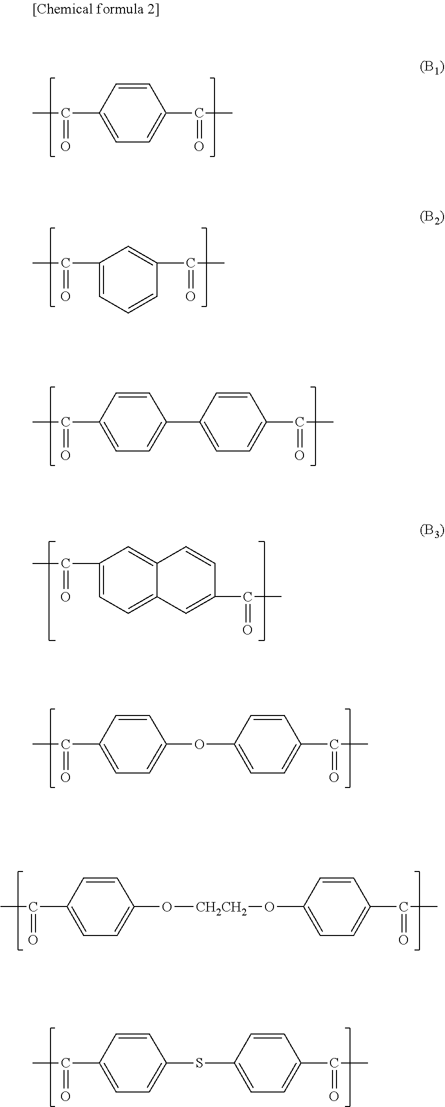

Examples of the aromatic diols include 4,4′-dihydroxybiphenyl (an aromatic diol that yields a repeating unit represented by (C₁) shown below), hydroquinone (an aromatic diol that yields a repeating unit represented by (C₂) shown below), resorcin (an aromatic diol that yields a repeating unit represented by (C₃) shown below), 4,4′-dihydroxydiphenyl ketone, 4,4′-dihydroxydiphenyl ether, bis(4-hydroxyphenyl)methane, 1,2-bis(4-hydroxyphenyl)ethane, 4,4′-dihydroxydiphenyl sulfone, 4,4′-dihydroxydiphenyl thioether, 2,6-dihydroxynaphthalene, 1,5-dihydroxynaphthalene, and aromatic diols in which a portion of the hydrogen atoms on the aromatic ring(s) of one of the above aromatic diols have each been substituted with at least one type of substituent selected from the group consisting of alkyl groups, aryl groups and halogen atoms. In the production of the liquid crystal polyester, one of the above aromatic diols may be used alone, or a combination of two or more aromatic diols may be used.

The repeating unit (3) described above includes a repeating unit derived from a specific aromatic diol. Examples of repeating units derived from an aromatic diol include the units shown below. The repeating unit derived from an aromatic diol may have a portion of the hydrogen atoms on the aromatic ring(s) each substituted with at least one type of substituent selected from the group consisting of halogen atoms, alkyl groups and aryl groups.

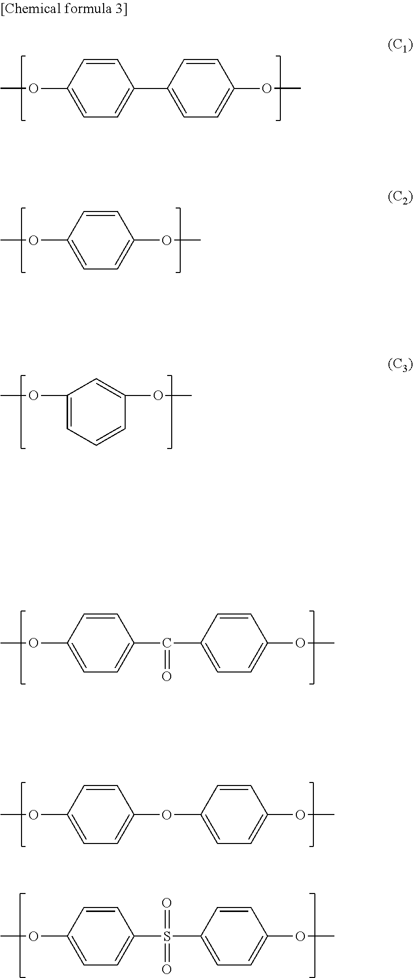

Of the substituents that the repeating unit (the repeating unit derived from an aromatic hydroxycarboxylic acid, repeating unit derived from an aromatic dicarboxylic acid, or repeating unit derived from an aromatic diol) may optionally have, examples of the halogen atom include a fluorine atom, a chlorine atom and a bromine atom. Of the substituents, examples of the alkyl group include lower alkyl groups of about 1 to 4 carbon atoms such as a methyl group, ethyl group and butyl group, whereas examples of the aryl group include a phenyl group.

Next is a description of particularly favorable liquid crystal polyesters.

The liquid crystal polyester described above preferably has a repeating unit ((A₁)) derived from para-hydroxybenzoic acid, a repeating unit ((A₂)) derived from 2-hydroxy-6-naphthoic acid, or repeating units derived from both of these compounds as the repeating unit derived from an aromatic hydroxycarboxylic acid; preferably has a repeating unit selected from the group consisting of a repeating unit ((B₁)) derived from terephthalic acid, a repeating unit ((B₂)) derived from isophthalic acid and a repeating unit ((B₃)) derived from 2,6-naphthalenedicarboxylic acid as the repeating unit derived from an aromatic dicarboxylic acid; and preferably has a repeating unit ((C₂)) derived from hydroquinone, a repeating unit ((C₁)) derived from 4,4′-dihroxybiphenyl, or repeating units derived from both of these compounds as the repeating unit derived from an aromatic diol.

In terms of the combinations of these repeating units, the combinations represented by (a)′ to (h)′ described below are preferable.

(a)′: a combination composed of (At), (B₁) and (C₁), or a combination composed of (A₁), (B₁), (B₂) and (C₁).

(b)′: a combination composed of (A₂), (B₃) and (C₂), or a combination composed of (A₂), (B₁), (B₃) and (C₂).

(c)′: a combination composed of (A₁) and (A₂).

(d)′: a combination of repeating units of (a)′, wherein a portion or all of (A₁) is replaced with (A₂).

(e)′: a combination of repeating units of (a)′, wherein a portion or all of (B₁) is replaced with (B₃).

(f)′: a combination of repeating units of (a)′, wherein a portion or all of (C₁) is replaced with (C₃).

(g)′: a combination of repeating units of (b)′, wherein a portion or all of (A₂) is replaced with (A₁).

(h)′: a combination of repeating units of (c)′, to which (B₁) and (C₂) have been added.

Examples of particularly preferable liquid crystal polyesters include liquid crystal polyesters in which relative to the total number of moles of all the repeating units: the total number of moles of repeating units derived from an aromatic hydroxycarboxylic acid that are repeating units ((A₁)) derived from para-hydroxybenzoic acid, repeating units ((A₂)) derived from 2-hydroxy-6-naphthoic acid, or repeating units derived from both of these compounds is from 30 to 80 mol %; the total number of moles of repeating units derived from an aromatic diol that are repeating units ((C₂)) derived from hydroquinone, repeating units ((C₁)) derived from 4,4′-dihydroxybiphenyl, or repeating units derived from both of these compounds is from 10 to 35 mol %; and the total number of moles of repeating units derived from an aromatic dicarboxylic acid that are selected from the group consisting of repeating units ((B₁)) derived from terephthalic acid, repeating units ((B₂)) derived from isophthalic acid, and repeating units ((B₃)) derived from 2,6-naphthalenedicarboxylic acid is from 10 to 35 mol %.

The above total of all the repeating units does not exceed 100 mol %.

Conventional methods such as the method disclosed in JP 2002-146003 A can be used as the method for producing the liquid crystal polyester. In other words, one method that may be used involves subjecting the raw material monomer described above (the aromatic hydroxycarboxylic acids, aromatic dicarboxylic acids, aromatic diols, or ester-forming derivatives thereof) to melt polymerization (polycondensation) to obtain an aromatic polyester of comparatively low molecular weight (hereinafter abbreviated as “the prepolymer”), and subsequently converting this prepolymer to a powder and performing a solid-phase polymerization by heating. By performing this type of solid-phase polymerization, the polymerization progresses, and a liquid crystal polyester of higher molecular weight can be obtained.

In addition, methods for producing liquid crystal polyesters having combinations of repeating units described above in (a)′ or (b)′, which represent the most basic structures, are also disclosed in JP S47-47870 B and JP S63-3888 B.

The melt polymerization may be performed in the presence of a catalyst, and in such cases, examples of the catalyst include metal compounds such as magnesium acetate, stannous acetate, tetrabutyl titanate, lead acetate, sodium acetate, potassium acetate and antimony trioxide, and nitrogen-containing heterocyclic compounds such as 4-(dimethylamino)pyridine and 1-methylimidazole. A nitrogen-containing heterocyclic compound is preferably used.

The liquid crystal polyester used in the method for manufacturing a resin molded body of the present embodiment is preferably a liquid crystal polyester having a flow beginning temperature determined by the method described below of 280° C. or higher. In those cases where, as described above, a solid-phase polymerization is used in the production of the liquid crystal polyester, ensuring that the flow beginning temperature of the liquid crystal polyester is 280° C. or higher can be achieved in a comparatively short time. Further, by using a liquid crystal polyester having this type of flow beginning temperature, the obtained molded body exhibits a high degree of heat resistance. On the other hand, in terms of enabling molding of the molded body within a practical temperature range, the flow beginning temperature of the liquid crystal polyester used in the resin molded body of the present embodiment is preferably not higher than 420° C., and is more preferably 390° C. or lower.

In other words, in one aspect, the flow beginning temperature of the liquid crystal polyester used in the method for manufacturing a resin molded body that represents one embodiment of the present invention is preferably at least 280° C. but not higher than 420° C., and is more preferably at least 280° C. but not higher than 390° C.

The “flow beginning temperature” is the temperature that yields a melt viscosity of 4,800 Pa·s (48,000 poise) when the liquid crystal polyester is extruded from a nozzle under a load of 9.8 MPa (100 kg/cm²) and at a rate of temperature increase of 4° C./minute using a capillary rheometer fitted with a die having an inner diameter of 1 mm and a length of 10 mm. The flow beginning temperature is an indicator of the molecular weight of liquid crystal polyesters that is known in the technical field (see Naoyuki Koide (ed.), “Liquid Crystal Polymers—Synthesis, Molding, Applications”, pages 95 to 105, CMC Publishing Co., Ltd., Jun. 5, 1987). An example of a device that may be used for measuring the flow beginning temperature is a flow characteristics evaluation device “Flow Tester CFT-500D” manufactured by Shimadzu Corporation.

The amount of the liquid crystal polyester, relative to the total mass of the resin composition used in the method for manufacturing a resin molded body of the present embodiment, is preferably from 40 to 80% by mass.

In another aspect, the amount of the liquid crystal polyester, relative to the total mass of the resin molded body obtained using the manufacturing method of the present embodiment, is preferably from 40 to 80% by mass.

### [Filler]

The resin composition used in the method for manufacturing a resin molded body that represents one embodiment of the present invention (namely, the resin molded body obtained using the manufacturing method that represents one embodiment of the present invention) may also contain a filler. In the present embodiment, by including a filler in the resin composition (namely, the resin molded body obtained using the manufacturing method of the present embodiment), the resin molded body can be imparted with adequate strength.

The filler used in the method for manufacturing a resin molded body that represents one embodiment of the present invention may be an inorganic filler or an organic filler. Further, the filler may be a fibrous filler, a plate-like filler, or a granular filler.

Examples of fibrous fillers include glass fiber; carbon fiber such as PAN-based carbon fiber and pitch-based carbon fiber; ceramic fiber such as silica fiber, alumina fiber and silica-alumina fiber; and metal fiber such as stainless steel fiber. Additional examples include whiskers such as potassium titanate whiskers, barium titanate whiskers, wollastonite whiskers, aluminum borate whiskers, silicon nitride whiskers and silicon carbide whiskers.

Examples of plate-like fillers include talc, mica, graphite, wollastonite, barium sulfate and calcium carbonate. The mica may be muscovite, phlogopite, fluorphlogopite or tetrasilic mica.

Examples of granular fillers include silica, alumina, titanium oxide, boron nitride, silicon carbide and calcium carbonate.

The amount of the filler, relative to the total mass of the resin composition, is preferably from 20 to 60% by mass.

In another aspect, the amount of the filler, relative to the total mass of the resin molded body obtained using the manufacturing method of the present embodiment, is preferably from 20 to 60% by mass.

### [Other Components]

The resin composition used in the method for manufacturing a resin molded body that represents one embodiment of the present invention may also contain other components that correspond with neither the liquid crystal polyester nor the filler described above, provided the effects of the present invention are not impaired.

In other words, in one aspect, the resin composition used in the method for manufacturing a resin molded body that represents one embodiment of the present invention contains a liquid crystal polyester, a filler, and other components as required.

In another aspect, the resin molded body obtained using the manufacturing method of the present embodiment contains a liquid crystal polyester, a filler, and other components as required.

Examples of the above-mentioned other components include the types of additives typically used in resin molded bodies, including releasability improvers such as fluororesins and metal soaps; colorants such as dyes and pigments; antioxidants; thermal stabilizers; ultraviolet absorbers; antistatic agents; and surfactants and the like.

Further examples of the other components include components having an external lubricant effect such as higher fatty acids, higher fatty acid esters, metal salts of higher fatty acids, and fluorocarbon-based surfactants.

Moreover, yet more examples of the other components include thermosetting resins such as phenol resins, epoxy resins and polyimide resins.

The amount of these other components, relative to the total mass of the resin composition, is preferably from 0 to 10% by mass.

In another aspect, the amount of the other components, relative to the total mass of the resin molded body obtained using the manufacturing method of the present embodiment, is preferably from 0 to 10% by mass.

The resin composition used in the present embodiment can be obtained by mixing the liquid crystal polyester, the filler, and any other components that are used as required, either in a single batch or in an appropriate order.

In another aspect, the resin composition used in the present embodiment is preferably obtained by subjecting the liquid crystal polyester, the filler, and any other components that are used as required to melt kneading and pelletization using an extruder.

### [Injection Molding]

The method for manufacturing a resin molded body that represents one embodiment of the present invention includes performing injection molding of a resin composition containing the liquid crystal polyester described above using a mold for forming the resin molded body.

When an attempt is made to injection mold a large resin molded body using a typical resin composition, a configuration can be conceived in which a mold is used that has one point-like gate for injection molding set in the central portion of the mold when viewed in plan view, and the resin composition is injected into the cavity from this one gate and molded. In this description, the “cavity” is the space inside the mold used in the present invention that is filled with the resin composition, with the cavity having a shape that corresponds with the target resin molded body.

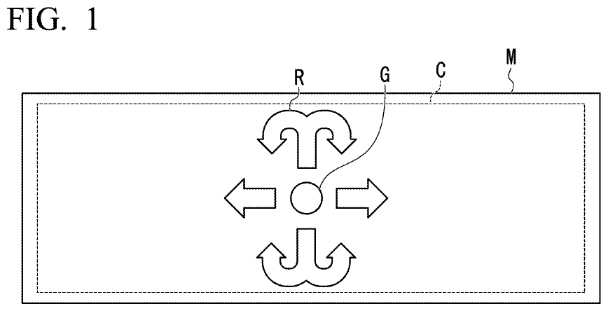

FIG. 1 is a schematic plan view illustrating the flow of the resin composition when producing a rectangular resin molded body using a mold having one point-like gate set in the central portion of the mold. In the drawings mentioned below, a white arrow indicated by a symbol R indicates the flowing melted resin. The size of the white arrow indicates the amount of flow of the flowing resin, with a larger white arrow indicated a larger amount of flow.

In a mold M illustrated in FIG. 1, a melted resin R injected into a cavity C from a gate G flows through the inside of the cavity C in the direction of the arrows, and then cures. Further, in the vicinity of the gate G, flow of the melted resin R in irregular directions can sometimes occur.

On the other hand, compositions containing a liquid crystal polymer such as a liquid crystal polyester have the properties that (A) the melted resin tends to orient readily along the flow direction, and (B) when the melted resin flow stops, the resin tends to cure readily.

If consideration is given to performing molding using this type of liquid crystal polymer resin composition, using the type of mold for molding a large resin molded body described above, it is thought that the following types of phenomena may occur. First, the melted resin (liquid crystal polymer) that spreads radially from the point-like gate orients along the resin flow direction. Further, in locations where the flow of the radially spread melted resin (liquid crystal polymer) stops, curing occurs with the irregular orientation maintained. As a result of these factors, it is thought that internal stress is likely to be retained in irregular directions in the obtained resin molded body, and warping is likely to occur.

As a result of intensive investigations relating to these types of issues, the inventors of the present invention focused their attention on the shape of the cavity and the position of the gate, and discovered a manufacturing method in which, by controlling the flow of the melted resin, the warping during molding could be reduced, thereby completing the present invention. Further, they also found that the resin molded body obtained using the method for manufacturing a resin molded body according to the present embodiment also exhibited reduced warping following heating.

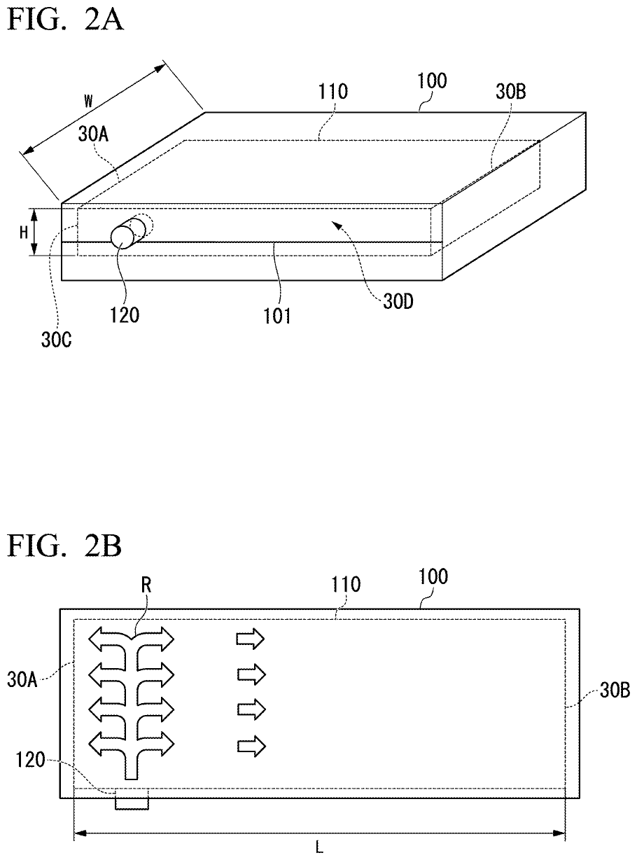

FIG. 2 shows schematic diagrams illustrating the method for manufacturing a resin molded body using a mold that represents one embodiment of the present invention. FIG. 2(A) is a perspective view and FIG. 2(B) is a plan view. FIG. 2(B) is a drawing that corresponds with FIG. 1. As illustrated in FIG. 2, a mold 100 used in the present embodiment has a cavity 110 and a gate 120.

The cavity 110 is a space having a shape corresponding with the resin molded body described below. In FIG. 2, the cavity 110 is illustrated as having a substantially rectangular shape in plan view. The resin molded body molded inside the cavity 110 can be removed by separating the mold 100 into upper and lower pieces along a parting line 101.

The gate 120 is provided in a position that is offset to one end side in the long-length direction of the cavity 110. In FIGS. 2(A) and 2(B), the gate 120 is provided in a position offset to one short side 30A of the cavity 110. Further, in FIGS. 2(A) and 2(B), the gate 120 is attached to a side surface 30D of the inner wall of the cavity 110. In the present embodiment, the distance, in the long-length direction of the cavity 110, from the center of the gate 120 to the closer end edge 30C of the side surface 30D (namely, the shortest distance from the center of the gate 120 to the short-length direction side surface of the cavity 110 positioned closest to the gate) is preferably at least 0% but not more than 8%, more preferably at least 0% but not more than 6%, and even more preferably at least 0% but not more than 4%, of the length of the long-length direction of the cavity 110.

In other words, in one aspect, in the method for manufacturing a resin molded body using a mold that represents one embodiment of the present invention, the distance from the center of the gate 120 in the mold (the center of a circumscribed circle of the cross-section of the gate perpendicular to the injection direction) to the end edge 30C of the cavity 110 (the shortest distance from the center of the gate 120 to the short-length direction side surface of the cavity 110 positioned closest to the gate) is preferably at least 0% but not more than 8%, more preferably at least 0% but not more than 6%, and even more preferably at least 0% but not more than 4%, of the length of the long-length direction of the cavity 110.

In FIG. 2(A), the gate 120 was illustrated as a cylindrical gate, but this is not a restriction. The cross-sectional shape of the gate 120 may be any conventional shape such as a circular, semicircular, elliptical, square, rectangular (oblong), trapezoidal, or other similar shape. For example, the gate 120 may be a film gate that extends along one short side 30A of the cavity 110.

Provided the condition described above is satisfied, the gate 120 may be provided at any position on the cavity. For example, the gate may be provided on the upper surface, lower surface or a side surface of the inner wall of the cavity 110.

In the manufacturing method of the present embodiment, it is preferable that the gate 120 is provided on only one side of the cavity 110 in the long-length direction of the cavity 110 (for example, on the side of one short side 30A, namely one of the long-length direction end portions). This ensures that the flow direction of the liquid crystal polyester is less likely to be disturbed.

Further, in those cases where the gate 120 is provided on only one side of the cavity 110, although there are no particular limitations on the number of gates 120, one gate is preferable. This ensures that the flow direction of the liquid crystal polyester is less likely to be disturbed.

By using a mold having this type of gate 120, the direction in which internal stress develops in the obtained resin molded body is more easily uniformly controlled. Accordingly, in the method for manufacturing a resin molded body that represents one embodiment of the present invention, warping upon molding and upon heating of the resin molded body is reduced.

The mold 100 satisfies the following conditions (b) to (d).

(b) The ratio (L/W) of the length (L) of the long-length direction of the cavity 110 relative to the length (W) of the short-length direction of the cavity 110 is two or greater.

(c) The length (L) of the long-length direction of the cavity 110 is 200 mm or greater.

(d) The thickness (H) of the cavity 110 is at least 0.5 mm but not more than 3.0 mm.

In the present description, the cavity of the mold has a shape that corresponds with the resin molded body, and that shape is defined as the rectangular shape that circumscribes the cavity.

In the present description, the “long-length direction of the cavity 110” means the long-length direction of the rectangular shape obtained when the plan view shape of the cavity 110 is approximated by a rectangular shape that circumscribes the cavity 110. Further, the “length of the long-length direction of the cavity 110” is the maximum length achievable along the long-length direction of the cavity 110, and indicates the length of the long side of the above rectangular shape.

The “short-length direction of the cavity 110” means the short-length direction of the above rectangular shape. Further, the “length of the short-length direction of the cavity 110” means the maximum length achievable along the short-length direction of the cavity 110, and indicates the length of the short side of the above rectangular shape.

The “thickness of the cavity 110” is the maximum length along the thickness direction of the cavity 110.

The “thickness direction” means the direction perpendicular to the plane that contacts the upper surface of the cavity 110. In those cases where the target resin molded body has ribs, the thickness of the cavity 110 is measured in a region excluding the portions corresponding with the ribs.

In another aspect, the “thickness of the cavity 110” means the shortest distance from the upper surface of a horizontal surface to the highest portion of the cavity 110 when the broadest surface of the cavity 110 is placed on the horizontal surface.

Further, “plan view” means viewed from above the horizontal surface.

If production of a resin molded body using the mold 100 is considered, it is thought that the following types of phenomena may occur. As illustrated in FIGS. 2(A) and (B), when melted resin R is caused to flow from the gate 120 that is installed offset to one short side 30A toward the other short side 30B, the flow direction of the liquid crystal polyester and the long-length direction of the cavity 110 tend to readily become substantially parallel. In other words, the orientation direction of the resin (liquid crystal polyester) readily adopts the desired direction. As a result, the direction in which internal stress develops in the obtained resin molded body is more easily uniformly controlled. Accordingly, in the method for manufacturing a resin molded body that represents one embodiment of the present invention, warping upon molding and upon heating of the resin molded body is reduced.

Here, the “desired direction” means the direction of the benzene ring main chain in the liquid crystal polyester.

If the gate 120 is a film gate mentioned above, then the flow direction of the liquid crystal polyester can be easily controlled to become substantially parallel with the long-length direction of the cavity 110.

In the injection molding performed in the manufacturing method of the present embodiment, molding may be conducted with the cylinder temperature of the injection molding machine preferably set to at least 300° C. but not more than 400° C., and the mold temperature preferably set to at least 40° C. but not more than 160° C.

In the injection molding performed in the manufacturing method of the present embodiment, the injection speed may be set appropriately in accordance with the type of liquid crystal polyester being used, but the faster the injection speed, the more easily the orientation direction of the liquid crystal polyester can be aligned. As a result, a resin molded body having less warping tends to be obtained. The injection speed is, for example, preferably at least 30 mm/s but not more than 600 mm/s, and is more preferably at least 50 mm/s but not more than 400 mm/s.

Provided the ratio (L/W) described in the above condition (b) is at least 2 but not more than 200, the direction of flow of the liquid crystal polyester from the gate 120 toward the other short side 30B and the long-length direction of the cavity 110 more readily become substantially parallel. The ratio (L/W) is preferably at least 3 but not more than 200.

Provided the length (L) of the long-length direction of the cavity 110 described in the above condition (c) is at least 200 mm but not more than 1,000 mm, the direction of flow of the liquid crystal polyester from the gate 120 toward the other short side 30B and the long-length direction of the cavity 110 more readily become parallel.

Provided the thickness (H) of the cavity 110 described in the above condition (d) is at least 0.5 mm, the liquid crystal polyester flows more readily. Further, provided the thickness (H) is not more than 3.0 mm, the liquid crystal polyester flows through the cavity 110 as filling occurs. As a result, the orientation direction of the resin (liquid crystal polyester) can be controlled in the desired direction.

In other words, the thickness (H) of the cavity 110 described in the condition (d) is preferably at least 0.5 mm but not more than 3.0 mm.

The method for manufacturing a resin molded body that represents one embodiment of the present invention preferably also satisfies the following condition (e) in addition to the conditions (a) to (d) described above.

(e) The ratio (W/H) of the length of the short-length direction (W) of the cavity 110 relative to the thickness (H) of the cavity 110 is at least 10 but not more than 200.

Provided the ratio (W/H) described in the above condition (e) is at least 10, the liquid crystal polyester flows through the cavity 110 as filling occurs. As a result, the orientation direction of the liquid crystal polyester can be controlled in the desired direction.

As a result of the above, the present embodiment provides a method for manufacturing a resin molded body that enables a favorable resin molded body to be manufactured using a liquid crystal polyester as a forming material.

### <Resin Molded Body>

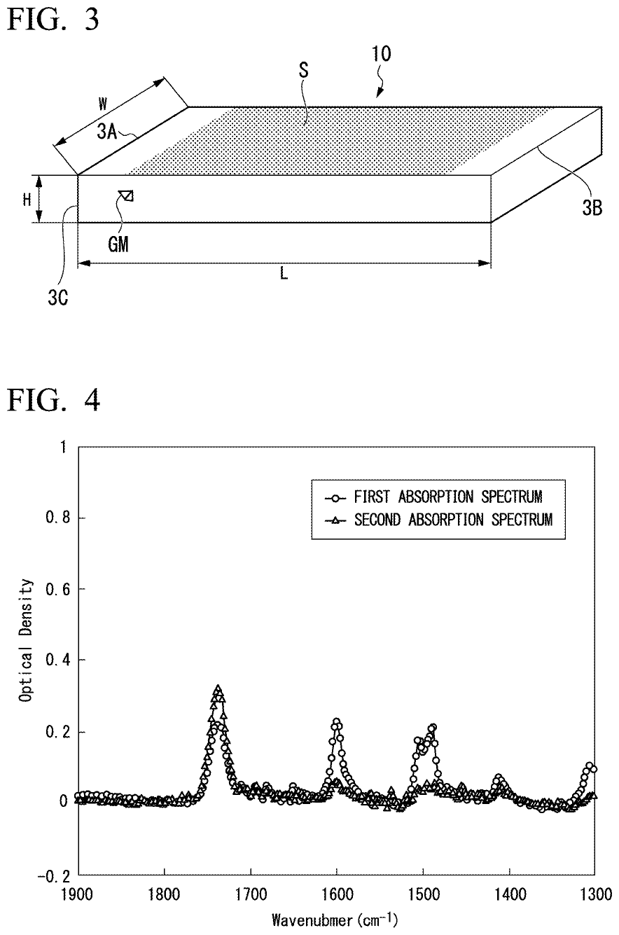

A resin molded body obtained using the method for manufacturing a resin molded body according to an embodiment of the present invention satisfies the following conditions (i) to (iv). FIG. 3 is a schematic perspective view illustrating a resin molded body of the present embodiment.

(i) The resin molded body has a gate mark GM provided in a position where the distance from an end edge 3C of the resin molded body 10 in the long-length direction of the resin molded body 10 illustrated in FIG. 3 (namely, the shortest distance from the short side of the resin molded body 10) is at least 0% but not more than 10% of the length of the long-length direction of the resin molded body 10.

(ii) The ratio (L/W) of the length (L) of the long-length direction of the resin molded body 10 relative to the length (W) of the short-length direction of the resin molded body 10 is at least 2 but not more than 200.

(iii) The length (L) of the long-length direction of the resin molded body 10 is at least 200 mm but not more than 1,000 mm.

(iv) The thickness (H) of the resin molded body 10 is at least 0.5 mm but not more than 3.0 mm.

The position of the gate mark GM in the resin molded body 10 illustrated in FIG. 3 corresponds with the position of the gate 120 of the mold 100 illustrated in FIG. 2.

In the resin molded body 10 that represents one embodiment of the present invention, the ratio (L/W) described in the above condition (ii) is preferably at least 3 but not more than 200.

The resin molded body 10 that represents one embodiment of the present invention preferably satisfies the following condition (v) in addition to the conditions (i) to (iv) described above.

(v) The ratio (W/H) of the length of the short-length direction (W) of the resin molded body 10 relative to the thickness (H) of the resin molded body 10 is at least 10 but not more than 200.

The length (W) of the short-length direction of the resin molded body 10 is preferably at least 5 mm but not more than 100 m.

In the resin molded body 10 that represents one embodiment of the present invention, the orientation direction of the liquid crystal polyester has adopted the desired direction. The fact that the orientation direction of the liquid crystal polyester has adopted the desired direction can be confirmed from the degree of orientation, which is calculated based on the results of measurement of the polarized infrared absorption spectrum of the resin molded body 10 of the present embodiment. The “degree of orientation” indicates the degree of orientation of the resin (see “Molecular Orientation by Infrared Dichroism”, authored by Yasuji Kobayashi, Kobunshi, Vol. 15, No. 175).

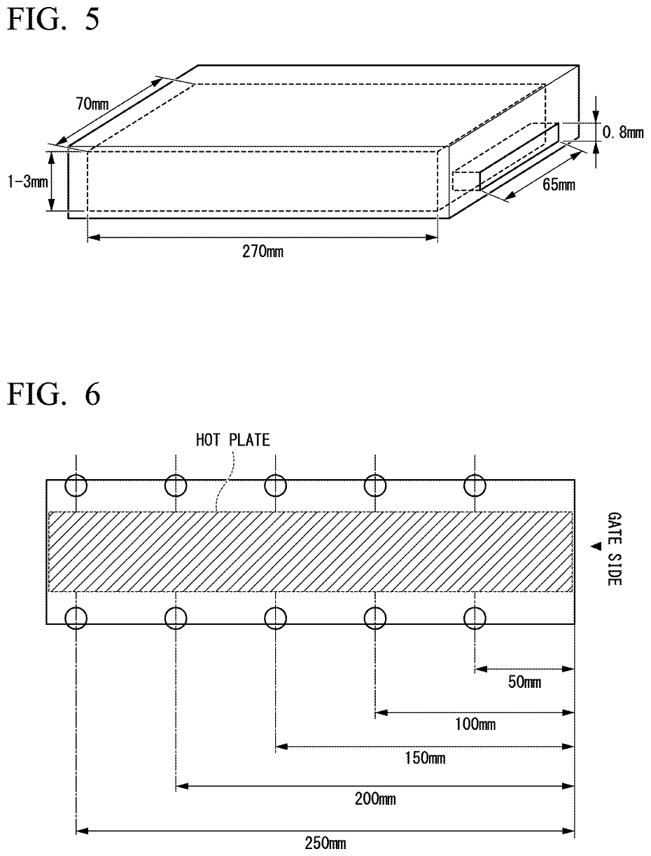

FIG. 4 is a diagram illustrating polarized infrared absorption spectra of the resin molded body 10 that represents one embodiment of the present invention.

The absorption spectrum using polarized infrared rays is measured in the manner described below.

First, the plane (plane of incidence) that is orthogonal to the upper surface of the long resin molded body 10 when viewed in plan view and also parallel to the lengthwise direction of the resin molded body 10 is determined.

Subsequently, using polarized infrared rays for which the vibration direction is parallel to the plane of incidence (sometimes referred to as the first infrared rays), the absorption spectrum is measured in the center of the upper surface of the resin molded body 10.

Further, using polarized infrared rays for which the vibration direction is orthogonal to the plane of incidence (sometimes referred to as the second infrared rays), the absorption spectrum is measured in the center of the upper surface of the resin molded body 10.

As illustrated in FIG. 4, in the absorption spectrum measured in this manner, a peak derived from the stretching vibration of the two-dimensionally aligned benzene rings is observed in a region from 1470 cm⁻¹ to 1510 cm⁻¹ in the polarized infrared absorption spectrum of the resin molded body 10 that represents one embodiment of the present invention. In the above measurement, a first absorption spectrum obtained by measurement using the first polarized infrared rays and a second absorption spectrum obtained by measurement using the second polarized infrared rays are obtained.

In the present embodiment, using the cumulative value for the optical density corresponding with the range from 1470 cm⁻¹ to 1510 cm⁻¹ in the polarized infrared absorption spectra in the center of the upper surface of the resin molded body 10, the degree of orientation f calculated based on formula (I) and formula (II) shown below is preferably at least 0.40 but less than 1.00.

D=(X₁/X₂) (I)

f=(D−1)/(D+2) (II)

(In formula (I), X₁ represents the cumulative value for the optical density in the first absorption spectrum; and X₂ represents the cumulative value for the optical density in the second absorption spectrum.)

In the present embodiment, a plurality of optical densities are measured discretely in the range from 1470 cm⁻¹ to 1510 cm⁻¹. More specifically, in the present embodiment, a plurality of optical densities are measured every 2 cm⁻¹ in the range from 1470 cm⁻¹ to 1510 cm⁻¹. The values represented by X₁ and X₂ in the above formula (I) are values obtained by totaling the plurality of measured optical density values. Further, the optical density may also be measured continuously across the range from 1470 cm⁻¹ to 1510 cm⁻¹. In that case, the values represented by X₁ and X₂ in the above formula (I) become the peak surface areas in the polarized infrared absorption spectra.

The center of the upper surface of the resin molded body 10 indicates a region described below.

First, the portion of the resin molded body 10 that excludes those portions for which the length, in the long-length direction of the resin molded body 10, to an end edge 3A or end edge 3B of the resin molded body 10 is not more than 10% of the length of the long-length direction of the resin molded body 10 is deemed the central portion S of the resin molded body 10.

In another aspect, the portion of the resin molded body 10 remaining upon excluding portions for which the shortest distance, in the long-length direction of the resin molded body 10, from the short-length direction edges of the resin molded body 10 (namely, the end edge 3A and the end edge 3B) is not more than 10% of the length of the long-length direction of the resin molded body 10 is deemed the central portion S of the resin molded body 10.

The “center of the upper surface of the resin molded body 10” indicates a circular region that has a center in this central region S of the resin molded body 10 and has a diameter that is at least 10% but not more than 50% of the length of the short-length direction of the resin molded body 10. The peripheral portion of the resin molded body 10 is excluded from the above circular region.

Provided the degree of orientation f calculated based on the above formula (I) and the above formula (II) is at least 0.40 but less than 1.00, the liquid crystal polyester can be adjudged as having adopted a substantially oriented state. As a result, the resin molded body 10 of the present embodiment has substantially reduced warping upon molding and upon heating of the resin molded body.

In the present embodiment, in order to shift the degree of orientation f of the resin molded body to the high side of the above range, the injection speed during injection molding may be increased.

The resin molded body 10 of the present embodiment may have ribs. The number, shape and direction of extension of the ribs may be selected as desired in accordance with the desired performance for the resin molded body 10. Including ribs on the resin molded body 10 can reduce warping of the resin molded body 10, and also increase the rigidity.

The “ribs” in the molded article refer to protruding reinforcement portions which are provided on the edges or side walls or the like of a container to increase the strength and rigidity without increasing the thickness, or are provided on molded articles having a broad flat region such as the bottom or the like of a container for the purpose of preventing deformation such as warping or twisting (see “Fundamentals of Plastic Injection Molding <No. 4>” authored by Tohru Oka, Techniques and Skills, Japan Organization for Employment of the Elderly and Persons with Disabilities, 2000, No. 4, page 57).

As a result of the above, the present embodiment provides a resin molded body that suffers little warping upon molding and little warping upon heating.

In one aspect, when warping is evaluated using a method disclosed below in the examples, the resin molded body of the present embodiment has properties that include a difference between the maximum amount of warping upon molding and the maximum amount of warping following heating at 120° C. for one hour that is from 0.01 to 0.1, and preferably from 0.01 to 0.05, and a difference between the flatness upon molding and the flatness following heating at 120° C. for one hour that is from 0.01 to 0.1, and preferably from 0.01 to 0.05.

Preferred embodiments according to the present invention have been described above with reference to the appended drawings, but needless to say, the present invention is not limited to these examples. The various shapes and combinations and the like of the various constituent members mentioned in the examples described above are merely examples, and various modifications based on design requirements or the like can be made without departing from the scope of the present invention.

Another aspect of the method for manufacturing a resin molded body that represents one embodiment of the present invention is a method for manufacturing a long-length resin molded body using a liquid crystal polyester as a forming material, the method comprising:

obtaining a resin composition containing a liquid crystal polyester, a filler, and other components as required,

injecting the resin composition via a gate into a cavity of a mold that satisfies conditions (a) to (d) described below, and filling the cavity with the resin composition,

curing the filled resin composition, and

opening the mold, and removing the cured resin composition; wherein

the liquid crystal polyester has repeating units represented by general formulas (1) to (3) shown below,

the filler is a fibrous filler or a plate-like filler,

the amount of the liquid crystal polyester is from 40 to 80% by mass relative to the total mass of the resin composition, and

the amount of the filler is from 20 to 60% by mass relative to the total mass of the resin composition.

(a) The mold has a cavity of a shape corresponding with the resin molded body, and

a gate provided in a position where the distance from an end edge of the cavity in the long-length direction of the cavity is at least 0% but not more than 10%, preferably at least 0% but not more than 8%, more preferably at least 0% but not more than 6%, and even more preferably at least 0% but not more than 4%, of the length of the long-length direction of the cavity, and

particularly preferably has a gate provided on one end portion of the long-length direction of the cavity.

(b) The ratio of the length of the long-length direction of the cavity relative to the length of the short-length direction of the cavity is at least 2 but not more than 200, and preferably at least 3 but not more than 200.

(c) The length of the long-length direction of the cavity is at least 200 mm but not more than 1,000 mm, and preferably at least 200 mm but not more than 500 mm.

(d) The thickness of the cavity is at least 0.5 mm but not more than 3.0 mm, and preferably at least 1 m but not more than 3 mm.

—O—Ar¹—CO— (1)

—CO—Ar²—CO— (2)

—X—Ar³—Y— (3)

(In the formulas, Ar¹ represents a phenylene group, a naphthylene group, or a biphenylylene group; each of Ar² and Ar³ independently represents a phenylene group, a naphthylene group, a biphenylylene group, or a group represented by general formula (4) shown below; each of X and Y independently represents an oxygen atom or an imino group (—NH—); and one or more hydrogen atoms in the groups represented by Ar¹, Ar² and Ar³ may each be independently substituted with a halogen atom, an alkyl group or an aryl group.)

Moreover, the above manufacturing method may include performing injection molding under conditions including an injection molding machine cylinder temperature of at least 300° C. but not more than 400° C., a mold temperature of at least 40° C. but not more than 160° C., an injection speed of 30 to 600 mm/s, a holding pressure of 10 to 1,000 MPa, and a holding pressure time of 0.1 to 20 seconds.

In addition, the above manufacturing method may also include preparing the above mold.

Preparation of the mold may include manufacturing the mold, procuring the mold from a third party, installing the mold in the injection molding machine, and procuring an injection molding machine with the mold already installed from a third party.

Another aspect of the resin molded body that represents one embodiment of the present invention is a resin molded body that satisfies conditions (i) to (iv) described below,

having a liquid crystal polyester having repeating units represented by general formulas (1) to (3) shown below, a filler, and other components as required, wherein

the filler is a fibrous filler or a plate-like filler,

the amount of the liquid crystal polyester is from 40 to 80% by mass relative to the total mass of the resin molded body,

the amount of the filler is from 20 to 60% by mass relative to the total mass of the resin molded body, and

when the degree of orientation f is calculated based on formula (I) below and formula (II) below using the cumulative value for optical density corresponding with a range from 1470 cm⁻¹ to 1510 cm⁻¹ in the polarized infrared absorption spectra of the resin molded body, the degree of orientation f is at least 0.40 but less than 1.00, and preferably at least 0.41 but not more than 0.66.

(i) The resin molded body has a gate mark provided in a position where the distance from an end edge of the resin molded body in the long-length direction of the resin molded body is at least 0% but not more than 10% of the length of the long-length direction of the resin molded body.

(ii) The ratio of the length of the long-length direction of the resin molded body relative to the length of the short-length direction of the resin molded body is at least 2 but not more than 200.

(iii) The length of the long-length direction of the resin molded body is at least 200 mm but not more than 1,000 mm, and preferably at least 200 mm but not more than 500 mm.

(iv) The thickness (H) of the resin molded body is at least 0.5 mm but not more than 3.0 mm, and preferably at least 1 in but not more than 3 mm.

D=(X₁/X₂) (I)

f=(D−1)/(D+2) (II)

(X₁: the cumulative value for the optical density in the absorption spectrum when the plane of incidence is set parallel to the long-length direction of the resin molded body in the upper surface of the resin molded body when viewed in plan view, and measurement is conducted in the center of the upper surface using first polarized infrared rays having a vibration direction parallel to the plane of incidence.
X₂: the cumulative value for the optical density in the absorption spectrum when measurement is conducted in the center of the upper surface using second polarized infrared rays having a vibration direction orthogonal to the plane of incidence.)

### EXAMPLES

The present invention is described below in further detail using examples, but the present invention is in no way limited by these examples.

In the following examples, the following commercially available resins were used as forming materials for the resin molded bodies.

Liquid crystal polyester (sometimes abbreviated as LCP): SUMIKASUPER (a registered trademark) E6808LHF B Z, manufactured by Sumitomo Chemical Co., Ltd.

Polyethylene terephthalate (sometimes abbreviated as PET): Rynite (a registered trademark) FR530 BK507, manufactured by E.I. du Pont de Nemours and Company.

### Examples 1 to 3

FIG. 5 is a schematic perspective view illustrating a mold used in the present examples. Resin molded bodies were produced by performing injection molding of the LCP using the mold illustrated in FIG. 5. Further, in these examples, the gate was provided on an end portion in the long-length direction of the cavity illustrated in FIG. 5.

### (Mold)

Length (L) of long-length direction of cavity: 270 mm

Length (W) of short-length direction of cavity: 70 mm

Thickness (H) of cavity: 1 mm, 2 mm, 3 mm

In Examples 1 to 3, the injection molding conditions were as follows.

### (Molding Conditions)

Molding machine: SE180EV-HP, manufactured by Sumitomo Heavy Industries, Ltd.

Cylinder temperature: 350° C.

Mold temperature: 100° C.

Injection speed: 80 mm/s

Holding pressure: 20 MPa

Holding pressure time: 2 seconds

Cooling time: 30 seconds

### Comparative Examples 1 to 3

Resin molded bodies were produced by performing injection molding of the PET using the same mold as Example 1.

In Comparative Examples 1 to 3, the injection molding conditions were as follows.

### (Molding Conditions)

Molding machine: SE180EV-HP, manufactured by Sumitomo Heavy Industries, Ltd.

Cylinder temperature: 290° C.

Mold temperature: 100° C.

Injection speed: 40 mm/s

Holding pressure: 60 MPa

Holding pressure time: 10 seconds

Cooling time: 40 seconds

Examples 1 to 3 and Comparative Examples 1 to 3 were evaluated in the manner described below.

### [Evaluation of Moldability]

The moldability of each of the obtained resin molded bodies was recorded as “X” if a resin molded body was able to be produced by injection molding, and was recorded as “Y” if a resin molded body was unable to be produced.

### [Evaluation of Warping]

FIG. 6 is a plan view illustrating warping measurement points on a resin molded body of an example of the present invention. In FIG. 6, each “0” represents a measurement point. In those cases where warping of the resin molded body could be confirmed by visual inspection, the resin molded body was placed on a flat plate in a convex downward arrangement. On the other hand, in those cases where warping of the resin molded body could not be confirmed by visual inspection, the resin molded body was placed on a flat plate with the same orientation as the other resin molded bodies.

Subsequently, using a non-contact three-dimensional measuring device “Quick Vision PRO” manufactured by Mitutoyo Corporation, the height in the thickness direction from the flat plate was measured at the 12 measurement points illustrated in FIG. 6 (namely, the edge portions of the resin molded body at points 50 mm, 100 mm, 150 mm, 200 mm and 250 mm in the long-length direction from the short edge on the gate side of the resin molded body). The maximum amount of warping of the resin molded body was defined by the difference between the largest value and the smallest value among the heights at the 12 points. In those cases where the 12 measurement points are in flat portions of the resin molded body with no warping, namely in those cases where molding has occurred as designed, the amount of warping is zero. This measurement of the maximum amount of warping was conducted for the resin molded body following molding, and the resin molded body following heating on a 120° C. hotplate for one hour in the region illustrated by the diagonal line portion in FIG. 6 (namely, the region of the resin molded body that excludes the regions 1 mm in the short-length direction from the long edges).

Further, using the heights at the 12 points, the least squares method was used to calculate the least squares plane of the resin molded body. When the height of the least squares plane including the smallest value among the 12 points was moved in parallel, the distance to the highest point among the 12 heights was calculated as the flatness. This measurement of the flatness was conducted for the resin molded body following molding, and the resin molded body following heating on a 120° C. hotplate for one hour in the region illustrated by the diagonal line portion in FIG. 6 (namely, the region of the resin molded body that excludes the regions 1 mm in the short-length direction from the long edges). The evaluation results are shown in Table 1.

TABLE 1

| | | | | Comparative | Comparative | Comparative |
|---|---|---|---|---|---|---|
| | Example 1 | Example 2 | Example 3 | Example 1 | Example 2 | Example 3 |
| Resin | LCP | | | PET | | |
| Cavity thickness (mm) | 1 | 2 | 3 | 1 | 2 | 3 |
| Moldability | X | X | X | Y | X | X |
| Maximum warping upon molding (mm) | 0.08 | 0.12 | 0.05 | — | 0.22 | 0.18 |
| Maximum warping upon heating (mm) | 0.11 | 0.13 | 0.08 | — | 0.42 | 0.29 |
| Maximum warping upon molding − | 0.03 | 0.01 | 0.03 | — | 0.21 | 0.11 |
| maximum warping upon heating (mm) | | | | | | |
| Flatness upon molding (mm) | 0.12 | 0.12 | 0.09 | — | 0.24 | 0.23 |
| Flatness following heating (mm) | 0.15 | 0.15 | 0.11 | — | 0.48 | 0.35 |
| Flatness upon molding − flatness upon | 0.03 | 0.02 | 0.02 | — | 0.24 | 0.13 |
| heating (mm) | | | | | | |

As shown in Table 1, when the cavity thickness was 1 mm, the example that used the PET (Comparative Example 1) suffered from short shot, and a resin molded body could not be obtained. In contrast, in the examples that used the LCP (Examples 1 to 3), resin molded bodies were able to be obtained. In other words, when the cavity thickness was 1 mm, the LCP exhibited superior moldability compared with the PET.

Among the examples in which resin molded bodies were obtained, the resin molded bodies obtained by injection molding of the LCP (Examples 1 to 3) exhibited less warping upon molding and upon heating than the resin molded bodies obtained by injection molding of the PET (Comparative Examples 2 and 3).

Examples 1 to 3 and Comparative Examples 2 and 3 were evaluated in the following manner.

### [Evaluation of Degree of Orientation]

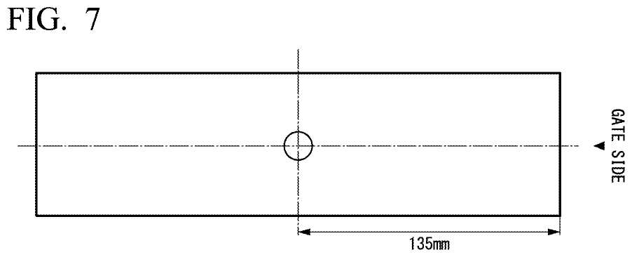

For each of the resin molded bodies of Examples 1 to 3 and Comparative Examples 2 and 3, the polarized infrared absorption spectrum was measured at the measurement point illustrated in FIG. 7. FIG. 7 is a plan view illustrating the measurement point (namely, the intersection point of a straight line in the short-length direction that is separated 135 mm in the long-length direction from the short edge on the gate side of the resin molded body, and a straight line in the long-length direction that passes through the center of the short edge) for measuring the polarized infrared absorption spectrum in a resin molded body of an example of the present invention, and is a drawing that corresponds with FIG. 6. In the obtained polarized infrared absorption spectrum, a plurality of optical density values were measured every 2 cm⁻¹ in the range from 1470 cm⁻¹ to 1510 cm⁻¹. The values represented by X₁ and X₂ in formula (I) are cumulative values of the plurality of measured optical density values. Using these X₁ and X₂ values, the degree of orientation f was calculated based on formula (I) and formula (II). The results are shown in Table 2.

D=(X₁/X₂) (I)

f=(D−1)/(D+2) (II)

(In formula (I), X₁ represents the cumulative value for the optical density in the flow direction of the resin; and X₂ represents the cumulative value for the optical density in a direction orthogonal to the flow direction.)

### (Measurement Conditions)

Device name: Model Cary 660, manufactured by Agilent Technologies, Inc.

Measurement method: polarized reflected IR method

Resolution: 4 cm⁻¹

Cumulative number: 128

Spectral transform: Kramers-Kroning transform

TABLE 2

| | Exam- | Exam- | Exam- | Comparative | Comparative |
|---|---|---|---|---|---|
| | ple 1 | ple 2 | ple 3 | Example 2 | Example 3 |
| Resin | LCP | | | PET | |
| X₁ | 2.55 | 2.47 | 2.32 | N.D. | N.D. |
| X₂ | 0.38 | 0.74 | 0.74 | N.D. | N.D. |
| D | 6.75 | 3.34 | 3.15 | — | — |
| Degree of | 0.66 | 0.44 | 0.42 | — | — |
| orientation f | | | | | |

As shown in Table 2, in the LCP injection molded examples (Examples 1 to 3), the degree of orientation f was in a range from at least 0.4 to less than 1.00. Based on these results, it is thought that the LCP in the resin molded body has adopted a substantially oriented state.

On the other hand, in the PET injection molded examples (Comparative Examples 2 and 3), a peak was not observed in the range from 1470 cm⁻¹ to 1510 cm⁻¹. Based on these results, it is thought that the benzene rings of the PET in the resin molded body exist in an isotropic arrangement, and have not adopted an oriented state.

The above results indicated that the present invention was useful.

### INDUSTRIAL APPLICABILITY

The present invention is able to provide a method for manufacturing a resin molded body that enables a favorable resin molded body to be manufactured using a liquid crystal polyester as a forming material, and a resin molded body obtained using this manufacturing method, and is therefore extremely useful industrially.

### DESCRIPTION OF THE REFERENCE SIGNS

3A: One end edge in a resin molded body
30A: One short side in a cavity
30B: The other short side in a cavity
10: Resin molded body
100: Mold
110: Cavity
120: Gate
GM: Gate mark

1. A method for manufacturing a long-length resin molded body using a liquid crystal polyester as a forming material, the method comprising:
injecting a resin composition containing the liquid crystal polyester via a gate into a cavity of a mold that satisfies conditions (a) to (d) below, and filling the cavity with the resin composition, wherein
(a) the mold has a cavity of a shape corresponding with the resin molded body, and a gate provided in a position where a distance from an end edge of the cavity in a long-length direction of the cavity is not more than 10% of a length of a long-length direction of the cavity,
(b) a ratio of a length of a long-length direction of the cavity relative to a length of a short-length direction of the cavity is two or greater,
(c) a length of a long-length direction of the cavity is 200 mm or greater, and
(d) a thickness of the cavity is at least 0.5 mm but not more than 3.0 mm.

2. The method for manufacturing a resin molded body according to claim 1, wherein the mold also satisfies a condition (e) below, in addition to the conditions (a) to (d):
(e) a ratio of the length of a short-length direction of the cavity relative to a thickness of the cavity is 10 or greater.

3. The method for manufacturing a resin molded body according to claim 1, wherein, in the condition (b), the ratio of the length of the long-length direction of the cavity relative to the length of the short-length direction of the cavity is three or greater.

4. A resin molded body that satisfies conditions (i) to (iv) below, wherein
(i) the resin molded body has a gate mark provided in a position where a distance from an end edge of the resin molded body in a long-length direction of the resin molded body is not more than 10% of a length of a long-length direction of the resin molded body,
(ii) a ratio of a length of a long-length direction of the resin molded body relative to a length of a short-length direction of the resin molded body is two or greater,
(iii) a length of a long-length direction of the resin molded body is 200 mm or greater, and
(iv) a thickness of the resin molded body is at least 0.5 mm but not more than 3.0 mm.

5. The resin molded body according to claim 4 which also satisfies a condition (v) below, in addition to the conditions (i) to (iv):
(v) a ratio of a length of a short-length direction of the resin molded body relative to a thickness of the resin molded body is 10 or greater.

6. The resin molded body according to claim 4, wherein
when a degree of orientation f is calculated based on formula (I) below and formula (II) below using a cumulative value for optical density corresponding with a range from 1470 cm⁻¹ to 1510 cm⁻¹ in a polarized infrared absorption spectra of the resin molded body, the degree of orientation f is at least 0.40 but less than 1.00:
D=(X₁/X₂) (I)
f=(D−1)/(D+2) (II)
X₁: a cumulative value for optical density in an absorption spectrum when a plane of incidence is set parallel to a long-length direction of the resin molded body in an upper surface of the resin molded body when viewed in plan view, and measurement is conducted in a center of the upper surface using first polarized infrared rays having a vibration direction parallel to the plane of incidence,
X₂: a cumulative value for optical density in an absorption spectrum when measurement is conducted in a center of the upper surface using second polarized infrared rays having a vibration direction orthogonal to the plane of incidence.

7. The resin molded body according to claim 4, comprising a filler, and a liquid crystal polyester having repeating units represented by general formulas (1) to (3) below:
—O—Ar¹—CO— (1)
—CO—Ar²—CO— (2)
—X—Ar³—Y— (3)
wherein Ar¹ represents a phenylene group, a naphthylene group, or a biphenylylene group; each of Ar² and Ar³ independently represents a phenylene group, a naphthylene group, a biphenylylene group, or a group represented by general formula (4) below; each of X and Y independently represents an oxygen atom or an imino group (—NH—); and one or more hydrogen atoms in a group represented by Ar¹, Ar² or Ar³ may each be independently substituted with a halogen atom, an alkyl group or an aryl group,
—Ar⁴—Z—Ar⁵— (4)
wherein each of Ar⁴ and Ar⁵ independently represents a phenylene group or a naphthylene group; and Z represents an oxygen atom, sulfur atom, carbonyl group, sulfonyl group or alkylidene group.

8. The resin molded body according to claim 7, wherein the filler is a fibrous filler or a plate-like filler.

9. The resin molded body according to claim 7, wherein relative to a total number of moles of all repeating units that constitute the liquid crystal polyester, an amount of repeating units represented by general formula (1) is from 30 to 80 mol %, an amount of repeating units represented by general formula (2) is from 10 to 35 mol %, and an amount of repeating units represented by general formula (3) is from 10 to 35 mol %.

10. The resin molded body according to claim 4, wherein in the condition (ii),
a ratio of a length of a long-length direction of the resin molded body relative to a length of a short-length direction of the resin molded body is three or greater.
